(19) United States
(12) Patent Application Publication
(10) Pub. No.: US 2007/0128367 A1
(43) Pub. Date: Jun. 7, 2007

(54) Method to adhere an expandable flexible polyurethane to a substrate

(76) Inventors: Rifat Tabakovic, Rochester Hills, MI (US); Huzeir Lekovic, Troy, MI (US); Frank V. Billotto, Oakland, MI (US); Ali El-Khatib, Dearborn, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/592,592

(22) PCT Filed: Mar. 8, 2005
(86) PCT No.: PCT/US05/07608

§ 371 Date: Sep. 12, 2006

Related U.S. Application Data
(60) Provisional application No. 60/553,188, filed on Mar. 15, 2004.

(51) Int. Cl. B05D 3/02

(52) U.S. Cl. 427/373; 427/374.1

(57) ABSTRACT

Foam-in-place, one component polyurethane compositions are useful to produce foams that adhere to various substrates such as certain vehicle parts and assemblies. The polyurethane composition contains a heat-activated blowing agent. The composition is based on a polyurethane resin that is expandable. The resin is a heat-softenable material, or a low molecular weight material that engages in further curing during the heat expansion step.

This application claims priority from U.S. Provisional Application No. 60/553,188 filed Mar. 15, 2004.

The present invention relates to expandable polyurethane foams and methods of forming such polyurethane foams at the surface of a substrate to provide, for example, vibrational dampening, acoustical insulation or cushioning.

Polyurethane foams have been used in the auto and other industries for a number of purposes, such as structural reinforcement, preventing corrosion and damping sound and vibration. In automotive applications, these foams are typically formed by applying a reactive foam formulation to or into a part or part cavity and allowing the formulation to foam in place. The part is often already assembled onto a vehicle when the foam is applied. This means that the foam formulation must be easy to mix and dispense, must cure rapidly before it runs off or out of the part or part cavity, and preferably initiates curing at moderate temperatures. To minimize worker chemical exposure, the formulation is preferably is low in volatile organic compounds, especially volatile isocyanates and amines. The individual formulation components are preferably storage-stable at room temperature for an extended period.

In building applications, foams are sometimes applied to wall and floor penetrations as air barrier foam sealants, for vibration dampening, and as underground mine shaft ventilation sealants to control the flow of fresh air pumped into the mine.

This “pour-in-place” type of process is useful mainly in cases where the polyurethane foam is a rigid foam, as flexible polyurethane foam formulations tend to cure more slowly due to the higher equivalent weight of the polyol materials. When flexible foams are used in these types of applications, the usual practice is to form the foam in the desired shape (by molding the foam or fabricating a slabstock foam), and then to attach the foam into place using an adhesive or other means. These foams are most often not polyurethanes, but some other elastomeric material (natural rubber or plastic) that is formed separately and then attached in place. Separately forming, shaping and attaching these foam structures adds significant cost to these foams.

It would therefore be desirable to provide a method by which a flexible polyurethane foam can be simply and inexpensively formed on and attached to various types of substrates.

This invention is a process for applying an adherent flexible polyurethane foam to a substrate, comprising

(a) applying to the substrate an expandable, one-component, bulk polyurethane composition, containing a polyurethane resin having dispersed therein (1) a surfactant and (2) a blowing agent that is heat-activated at an elevated temperature, then

(b) heating said bulk polyurethane composition to a temperature sufficient to activate said blowing agent to generate a gas, whereby said bulk polyurethane resin expands to form a flexible polyurethane foam adherent to the substrate, and

(c) then cooling the resulting polyurethane foam to a temperature below 40 C.

In this invention, a polyurethane foam is formed and attached to the substrate by applying a one-component polyurethane composition to the substrate, and then heating the polyurethane composition to a temperature at which the blowing agent generates a gas and expands the polyurethane composition. The polyurethane composition is “expandable”, which in the context of this invention means that it is capable of expanding as the blowing agent generates a gas at the elevated temperature to form a cellular material that, when cooled, forms a stable polymer foam. Such an expandable polyurethane composition is in general either heat-softenable, or in the form of a viscous paste- or putty-like material that cures to a high molecular weight polymer during the expansion step.

The polyurethane composition is applied as a bulk material as distinguished from a plurality of small particles. The polyurethane composition is preferably applied in contiguous portions of least 1 cubic centimeter, preferably at least 2 cubic centimeters, especially at least 5 cubic centimeters (prior to expansion). Because the polyurethane composition is a one-component formulation, it is not necessary to mix or properly ratio precursor materials in the field prior to application. The polyurethane composition is conveniently delivered as discrete, solid pieces (when heat-softenable), or packaged in a container such as a tube or other simple dispenser (when in the form of a paste or putty), and applied directly.

A heat-softenable polyurethane composition may be formed into predetermined shapes that are adapted for the particular application. For example, a heat-softenable polyurethane composition may be formed into cubes, spheres, cylinders, cones or more complex, specialized shapes that allow it to be squeezed into a cavity or other space where it mechanically holds itself in place until heated and expanded to form a foam. The composition is conveniently formed into such specific shapes by a molding process, as described more fully below. Specific shapes can be formed by fabricating them from a larger piece of the polyurethane composition. Heat-softenable polyurethane compositions instead may be held in place prior to expansion by a variety of other means, such as by various types of mechanical fasteners, through an adhesive, or by sealing it into place.

A paste- or putty-like polyurethane composition is typically somewhat tacky and can be applied directly to the substrate prior to being expanded, without relying on mechanical or adhesive means for holding it in place. This allows the polyurethane composition to be coated onto all surfaces of the substrate where the resultant foam is desired. Polyurethane compositions of this type will generally be an easily deformable (“thumbable”) material that can applied and spread under slight pressure (such as finger pressure) at temperatures of slightly below to slightly above room temperature (5-45° C., for example). As before, these paste- or putty-like polyurethane compositions may be used to adhere still other components to the substrate.

The expansion temperature will depend on the selection of blowing agent and the softening and/or curing characteristics of the polyurethane composition. Generally, however, heating to a temperature of about 100° C., preferably about 120° C., more preferably about 130° C., to about 220° C., preferably to about 195° C., more preferably to about 180° C. and even more preferably to about 160° C. is suitable. Heating at such temperatures is maintained until expansion and desired further curing is completed. This is generally accomplished in two hours or less, preferably from about 1-60 minutes, especially from about 1-15 minutes.

Expansion of the polyurethane composition is generally to at least 200% of its initial volume, to as much as 3500% or greater. The expansion is in most cases a matter of design choice, to obtain desired characteristics or functions in the foam. The amount of expansion can be varied by manipulating several parameters, including the softening temperature of the polyurethane resin, the crosslink density of the polyurethane resin, the type and amount of blowing agent that is used, and the heating conditions. A final foam density is advantageously in the range from about 1 (16), more preferably from about 2 (32), even more preferably from about 4 (64), especially from about 6 pcf (96 kg/m³) to about 30 (480), more preferably to about 20 (320), even more preferably to about 15 pcf (240 kg/m³).

After attaining the desired expansion and curing (if any), the resulting foam is then cooled to a temperature below 40° C. to stabilize the resulting foam structure.

The resulting polyurethane foam tends to have a high proportion of open cells and is generally elastomeric. However, more highly closed-celled, more rigid foams can be prepared in accordance with the invention when sufficient curing occurs in the expansion step to provide a highly crosslinked polymer structure, or when the foam has a higher density, such as above 10 pcf (160 kg/m³).

A variety of materials can serve as the substrate, with the main requirements being that the substrate must withstand the temperatures required to expand the polyurethane composition, and that the substrate and polyurethane composition do not engage in any undesired chemical or other interactions (such as bleeding, dissolving, plasticizing, etc.). Thus, the substrate may be a metal, a ceramic material, a high-melting thermoplastic resin, a thermoset resin, wood or other cellulosic material, a composite of two or more of these types of materials, and the like. The substrate is generally a designed part having a particular shape and size to perform a specific function. The substrate may be an assembly of two or more of such parts, if desired.

Substrates of particular interest include automotive body and chassis parts and assemblies. Examples of these include pillars, rockers, sills, sails, cowls, plenum, seams, frame rails, cross bar beams, engine cradles, other vehicle sub-assemblies and hydro-formed parts. They may be assembled onto a vehicle or vehicle frame when the foam formulation is applied and the attached foam is formed. Automotive parts such as these are often filled or covered with a foam material in order to provide acoustical insulation, vibration dampening, thermal insulation, structural reinforcement, corrosion protection, or other reasons. As the expanded polyurethane tends to be open-celled and elastomeric, it is particularly useful as acoustical insulation and/or vibration dampening.

The expanded foam may in addition be used as an adhesive through which other components are attached to the substrate. For example, molded foam inserts are often put into hollow cavities in vehicle parts and assemblies. The expanded polyurethane foam of this invention is useful to glue the inserts into place. This is accomplished by applying the polyurethane composition of the invention to the surface of the insert, and placing the coated insert into its desired location. When the polyurethane composition is heated and expands, it continues to perform as an adhesive while filling voids between the insert and the cavity wall. This allows for more complete cavity fills and allows the inserts to be shaped only approximately to that of the cavity, thereby reducing fabrication costs for the inserts.

Automotive body and chassis assemblies are often painted using coatings that require a high temperature cure. Coatings of this type are sometimes referred to as “E-coats”. When used in conjunction with parts or assemblies that will be painted and exposed to a high temperature cure, the preferred polyurethane compositions will expand and cure (when desired) under the same conditions as used to cure such coatings. In such instances, it is then possible and preferable to conduct the expansion step at the same time the coating is cured. In such a process, the polyurethane composition is applied to the part or assembly as required. The coating is applied to the part or assembly, or to a larger assembly of which the first part or assembly is a component, and the coated assembly is then subjected to the high temperature paint cure, at which time the polyurethane composition also expands. This process eliminates the need for separate heating steps to expand the polyurethane composition and to cure the paint. Typical temperatures for such paint curing operations are from about 130-155° C. When used in this manner, the polyurethane composition should not absorb or undesirably interact with the paint formulation, if the two come into contact prior to the curing/expansion step.

The polyurethane composition contains a heat-activated blowing agent, a surfactant, and polyurethane resin. It may also contain catalysts, initiators, and/or curing or crosslinking agents to promote the buildup of molecular weight during the expansion step. These components are selected so that the composition is expandable at the temperatures described before. The polyurethane composition can contain various auxiliary components such as plasticizers, diluents, modifiers, fillers, microspheres, colorants, odor masks, flame retardants, biocides, antioxidants, UV stabilizers, antistatic agents, thixotropic agents, free-radical polymerization inhibitors, free radical initiators and cell openers.

The blowing agent is suitably one that generates a gas at the aforementioned expansion temperatures. Suitable blowing agents include hydrocarbons, hydrofluorocarbons and fluorocarbons having boiling temperatures within the ranges indicated before. Preferred blowing agents are solids at room that generate a gas by thermal decomposition when exposed to such temperatures. A preferred blowing agent of this type is azodicarbonamide, which may be variously activated to adjust its activation temperature within a broad range. Commercially available azodicarbonamide blowing agents include Celogen™ 754A for Plastics (329-356° F. (165-180° C.) decomposition temperature), Celogen™ 765A for Plastics (306-320° F., 152-160° C.), Celogen™ 780 for Plastics (284-302° F.), Celogen™ AZ for plastics (˜401° F., ˜205° C.), Celogen™ AZ-760-A (˜392° F., ˜200° C.), Celogen™ AZNP-130 (˜392° F., ˜200° C.); Celogen™ AZRV (360-380° F., 182-193° C.), Celogen™ FF for plastics (˜392° F., ˜200° C.) and Celogen™ AZ-120, all available from Crompton Industries. Other solid, heat-decomposable blowing agents that can be used include sulfonyl hydrazides (such as Celogen™ OT for Plastics and Celogen™ TSH-C for plastics, both available from Crompton Industries), salts and esters of azodicarboxylic acid, p,p′-oxybis (benzenesulfonylhydrazide) (such as Celogen™ BH, from Crompton Industries), p-toluenesulfonylhydrazide (such as Celogen™ RA from Crompton Industries), benzenesulfonyl hydrazide, N,N′-dinitroso-N,N′-dimethyl terephthalamide, dinitrosopentamethylenetetramine and azobis(isobutyronitrile).

In addition, water that is encapsulated in an encapsulant that melts or degrades at the expansion conditions can be used as both a blowing agent and a crosslinking/chain extension agent.

The polyurethane composition contains a surfactant, such as those described by U.S. Pat. No. 4,390,645, which is incorporated by reference. Examples of surfactants include nonionic surfactants and wetting agents, such as those prepared by the sequential addition of propylene oxide and then ethylene oxide to propylene glycol, solid or liquid organosilicones, polyethylene glycol ethers of long chain alcohols, tertiary amine or alkanolamine salts of long chain alkyl acid sulfate esters, alkyl sulfonic esters and alkyl arylsulfonic acids. The surfactants prepared by the sequential addition of propylene oxide and then ethylene oxide to propylene glycol are preferred, as are the solid or liquid organosilicones. Non-hydrolyzable liquid organosilicones are more preferred. When a surfactant is used, it is typically present in an amount of about 0.0015 to about 1 percent by weight of the foam formulation. The surfactant is preferably incorporated into the resin component. Suitable surfactants include commercially available polysiloxane/polyether copolymers such as Tegostab (trademark of Goldschmidt Chemical Corp.) B-8462 and B-8404, DC-198 and DC-5043 surfactants, available from Air Products and Chemicals, and L-6900 surfactant available from OSi Specialty Products. The surfactant is conveniently present during the preparation of the polyurethane resin, but may be compounded into the resin if desired.

In order for the polyurethane composition to be expandable, the polyurethane resin must be a visco-elastic material at the temperatures encountered in the expansion step, so that it will trap the gases generated by the blowing agent to form a cellular structure. The polyurethane composition must then be capable of forming a stable foam structure when cooled. To do this, the polyurethane resin, prior to the expansion step, is a heat-softenable solid material or a viscous fluid. After the expansion step, the polyurethane resin is in the form of a solid, high molecular weight material that may or may not have a more highly crosslinked structure. If the starting polyurethane resin is a heat-softenable solid material with sufficient molecular weight to form a stable foam, further curing and/or crosslinking is not be necessary during the heat expansion step. In the case where the polyurethane resin is initially a viscous fluid, or otherwise does not have sufficient molecular weight to form a stable foam, the resin undergoes further curing and/or crosslinking during the expansion step to produce the high molecular weight polymer. When further curing is required or desired, the polyurethane resin will contain functional groups that can cause the polyurethane resin to react with itself or another component of the polyurethane composition to cure and/or crosslink under the conditions of the expansion step. When necessary, the polyurethane composition will in addition to the polyurethane resin contain one or more curing agents, crosslinkers, catalysts, or other curing aids. The curing/crosslinking mechanism is latent, in the sense that the curing/crosslinking reaction does not occur until the polyurethane composition is exposed to some condition, typically an elevated temperature that causes the curing/crosslinking reaction to occur. The curing/crosslinking reaction must of course be sequenced with the generation of gasses by the blowing agent.

Heat-Softenable Polyurethane Resins

Heat-softenable polyurethane resins are non-tacky, solid (at ˜20° C.) polymers that is non-crosslinked or only lightly crosslinked. Such polyurethane resins will act substantially like thermoplastic materials, softening at some elevated temperature at or below that at which the blowing agent generates a gas, so it can be expanded by the gas to form a cellular structure. This is generally accomplished when the molecular weight (Mₙ) of the polyurethane resin is about 25,000 or more, especially about 50,000 or more.

A suitable heat-softenable polyurethane resin softens at a temperature of 100° C. or higher, but below the decomposition temperature of the resin, so that it can be expanded by the generation of gasses by the blowing agent. A suitable heat-softenable polyurethane resin preferably exhibits such a softening temperature of at least 120° C., more preferably at least 130° C., but below 195° C., more preferably below 180° C., and even more preferably below 165° C. An especially preferred thermoplastic polyurethane resin has a softening temperature of between 130-155° C. Note that a polyurethane composition of the heat-softenable type may engage in curing reactions during the expansion process, similar to those in which the low molecular weight polyurethane resin types engage, to form a more stable foam structure.

The heat-softenable polyurethane resin is the reaction product of at least one polyisocyanate and at least one high equivalent weight isocyanate-reactive material. Because the heat-softenable polyurethane resin is non-crosslinked or only lightly crosslinked, it is prepared from materials and under conditions that disfavor the formation of a highly crosslinked polymer structure.

Crosslinking is typically introduced into polyurethane resins in several ways, such as (1) through the use of significant proportions of precursor materials having three or more reactive groups, (2) through biuret and allophonate formation, (3) through the use of a large excess of a polyisocyanate in conjunction with polymerization conditions (such as the presence of a trimerization catalyst) that favor a trimerization reaction; and (4) via use of aromatic chain extender compounds, particularly aromatic diamine chain extenders, which form high melting hard segments in the polyurethane (“virtual” crosslinks). Thus, suitable heat-softenable polyurethanes are preferably prepared (1) using starting materials that have an average nominal functionality (reactive groups/molecule) of less than about 3.0, especially less than about 2.7, particularly from about 1.8 to about 2.5; (2) using reaction conditions that do not favor substantial allophonate or biuret formation, (3) selecting precursor materials and conditions that do not favor significant polyisocyanate trimerization (such as the absence of trimerization catalysts and moderate polymerization conditions) and (4) the selection of precursor materials that contain small amounts of or no aromatic chain extenders, especially amine chain extenders.

Suitable polyisocyanates for making the heat-softenable polyurethane resin include aromatic, aliphatic and cycloaliphatic polyisocyanates. Aromatic polyisocyanates are generally preferred based on cost, availability and properties, although aliphatic polyisocyanates are preferred in instances where stability to light is important. Exemplary polyisocyanates include, for example, m-phenylene diisocyanate, 2,4- and/or 2,6-toluene diisocyanate (TDI), the various isomers of diphenylmethanediisocyanate (MDI), hexamethylene-1,6-diisocyanate, tetra methylene-1,4-diisocyanate, cyclohexane-1,4-diisocyanate, hexahydrotoluene diisocyanate, hydrogenated MDI (H₁₂ MDI), naphthylene-1,5-diisocyanate, methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4′-diisocyanate, 4,4′,4″-triphenylmethane diisocyanate, polymethylene polyphenylisocyanates, hydrogenated polymethylene polyphenylisocyanates, toluene-2,4,6-triisocyanate, and 4,4′-dimethyl diphenylmethane-2,2′,5,5′-tetraisocyanate. Preferred polyisocyanates include TDI, MDI and so-called polymeric MDI products. The polyisocyanate preferably has an average functionality (isocyanate groups/molecule) of up to about 3.0, preferably from about 1.7 to about 2.5, especially from about 2.0 to about 2.3.

High equivalent weight isocyanate reactive compounds for use in making a heat-softenable polyurethane resin preferably contain, on average, a nominal functionality (isocyanate-reactive groups/molecule) of up to about 3.0, preferably from about 1.7 to about 2.7, especially from about 2.0 to about 2.6. The isocyanate-reactive groups include hydroxyl, primary amino and secondary amino groups. Hydroxyl groups (primary or secondary) are preferred. “High equivalent weight” in this context means at least 400 daltons per isocyanate-reactive group. The high equivalent weight isocyanate-reactive compound preferably has an equivalent weight of at least about 600, preferably at least about 800, to about 5000, preferably to about 2500, and especially to about 1700.

Suitable high equivalent weight isocyanate-reactive compounds include polyether polyols and polyester polyols. Suitable polyether polyols include polymers of ethylene oxide, propylene oxide, 1,2-butylene oxide and tetrahydrofuran. Those of most interest are homopolymers of propylene oxide, random copolymers of propylene oxide and up to about 30% by weight ethylene oxide, poly(ethylene oxide)-capped poly(propylene oxide polymers having a high proportion of primary hydroxyl groups, and the like. These polyethers are prepared by polymerizing the monomers in the presence of an initiator compound having two or more hydroxyl, primary amino or secondary amino groups per molecule. The initiator compound sets the nominal functionality of the polyether and provides molecular weight control.

The nominal functionality of the polyether is equal to the average number of hydroxyl, primary amine and secondary amine groups on the initiator compound. The actual functionality of the polyether is sometimes lower, especially when propylene oxide is polymerized, due to side reactions that introduce terminal unsaturation onto the polyether chains. Because of this terminal unsaturation, it is preferred to use a polyether having a nominal functionality of somewhat greater than two up to about 3. Mixtures of nominally difunctional and nominally trifunctional polyethers having an average nominal functionality of about 2.0-2.6 are especially useful. If the polyether contains less than about 0.02 milliequivalents/gram of terminal unsaturation, the preferred nominal functionality is from about 1.8 to about 2.5.

Suitable high equivalent weight polyester polyols include polymers of a diacid (or, equivalently, a diacid chloride or diacid anhydride) and a low molecular weight compound having two hydroxyl groups. A polyester of adipic acid and 1,6-hexane diol is an example of such a polyester polyol. Polyester polyols are generally difunctional.

The high equivalent weight polyethers and polyesters may be treated to introduce terminal aliphatic and/or aromatic primary and/or secondary amine groups. Such materials are commercially available from Huntsman Chemicals under the trade name Jeffamine™.

Chain extenders may also be used to make the heat-softenable polyurethane resin. However, a well phase-segregated polyurethane having a high proportion of high melting “hard” phases will tend to be less readily heat-softened, as the “hard” phases sometimes melt only at very high temperatures and thus function as virtual crosslinks. For that reason, the quantities of these chain extenders, especially aromatic diamine chain extenders, are preferably limited. If used, chain extenders are typically present in an amount from about 0.05 to about 1, especially from about 0.1 to about 0.6, equivalents per equivalent of high equivalent weight isocyanate-reactive material. For the purposes of this invention, a “chain extender” is a material having two isocyanate-reactive groups per molecule and an equivalent weight per isocyanate-reactive group of less than 400 daltons, especially from 31-150 daltons. The isocyanate reactive groups may be hydroxyl, primary aliphatic or aromatic amine or secondary aliphatic or aromatic amine groups, but preferably are hydroxyl or aliphatic primary or secondary amino groups. Representative chain extenders include amines ethylene glycol, 1,4-butanediol, diethylene glycol, 1,2-propylene glycol, dipropylene glycol, tripropylene glycol, diethyltoluene diamine and ethylene diamine.

Crosslinkers may also be used to make the heat-softenable polyurethane resin, but are generally used sparingly or not at all. For purposes of this invention, “crosslinkers” are materials having three or more isocyanate-reactive groups per molecule and an equivalent weight per isocyanate-reactive group of less than 400 daltons. Crosslinkers preferably contain from 3-8, especially from 3-4, hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, and the like. It is preferred to use less than 0.5, especially less than 0.2 equivalents of a crosslinker per equivalent of high equivalent weight isocyanate-reactive material.

The heat-softenable polyurethane is made by reacting the polyisocyanate with the isocyanate-reactive materials described above (and any optional compounds, as discussed below, that impart functional groups for subsequent curing). The heat softenable polyurethane resin can be made in a one-step, prepolymer or quasi-prepolymer process. A convenient method of making the polyurethane resin is to bring the reaction materials to a mixing head where they are mixed and dispensed into a mold, where they cure to form the polyurethane resin. A suitable process is the so-called reaction injection molding process, in which the individual reactants are brought together through an impingement mixer and injected into a suitably shaped mold cavity or plurality of mold cavities. The reactants cure in the mold to form a substantially non-cellular resin that can then be demolded and used. The mold may or not be heated, depending on the starting materials, selection of catalysts and desired degree of cure. It is possible but usually not necessary to post-cure the parts. The parts are desirably shaped for insertion in particular cavities for particular applications.

Development of a sufficient molecular weight to form a solid, heat-softenable polymer is favored by using near-stoichiometric quantities of polyisocyanate and isocyanate-reactive materials. This ratio of materials is generally referred to as “isocyanate index”, which is the ratio of isocyanate groups to isocyanate-reactive groups in the formulation. An isocyanate index of about 0.9 to 1.15, especially from 0.98 to about 1.10, is generally suitable for preparing the heat-softenable polyurethane resin. At these isocyanate indices, addition curing mechanisms are not required. One can use lower or higher isocyanate indices to form the heat-softenable polyurethane resin, but in those cases it is usually necessary to provide a mechanism for additional curing during the expansion step.

It is generally preferred to form the heat-softenable polyurethane resin in the presence of the blowing agent, surfactant and other components of the final polyurethane composition. This simplifies the manufacturing process by eliminating subsequent compounding steps. When the resin is produced in this manner, conditions are selected such that (1) the blowing agent is not activated and (2) any functional groups provided to enable subsequent curing during the expansion step remain unreacted.

The former condition is achieved primarily through control of the reaction temperature. The polyurethane resin is formed under conditions such that the peak temperature generated in forming the resin is below that at which the blowing agent is activated to form a gas. As the polyurethane-forming reaction is often exothermic, care is taken to control the temperatures generated by the exotherm. Mechanisms by which such temperature control can be achieved include use of cooled or room temperature starting materials; use of a cooled reaction vessel or mold; addition of a diluent to provide a heat sink; control over polymerization catalyst types and amounts; selecting for higher average equivalent weight isocyanate-reactive materials; use of polyisocyanate prepolymers; or use of raw materials that react less exothermically.

Premature reaction of the functional groups that enable subsequent curing during the expansion step can be reduced or eliminated by several methods, such as control of the reaction temperature using methods as described above and avoidance of catalysts or initiators for the reactions of those functional groups, as discussed more fully below.

It is less preferred, but nonetheless within the scope of the invention, to form the heat-softenable polyurethane resin in a first step, and then separately compound the blowing agent, surfactant, curing agents, catalysts, and/or other components of the heat-softenable polyurethane resin to a temperature above its softening temperature. It is necessary in such instances not to expose the resin to conditions that activate the blowing agent or cause the functional groups that enable curing in the expansion step to react prematurely.

Curing agents and catalysts for the reaction of any functional groups can be compounded into the heat-softenable polyurethane resin in a second step after it is formed, but again temperature and/or other conditions must be controlled to avoid causing the functional groups to react during the compounding step. Curing agents may also be separately compounded into a heat-softenable polyurethane resin, with similar precautions to avoid premature curing.

Curable Polyurethane Resins

Polyurethane resins of this type are relatively low molecular weight, viscous fluids, or solids having a softening temperature below 100° C., that contain functional groups that enable them to cure under the conditions of the expansion step to a high molecular weight polymer. The functional groups can react with themselves, other functional groups on the resin, or with other materials that are formulated into the polyurethane composition to provide the requisite curing. Polyurethane compositions containing resins of this type are preferably formulated so they will engage in the desired curing reactions at temperatures from about 100° C., more preferably from about 120° C., even more preferably from about 130° C., to about 195° C., more preferably to about 180° C., even more preferably to about 165° C. Preferred polyurethane compositions will cure at some temperature within these ranges in a period of about 2 hours or less.

Curable polyurethane resins are made generally using the same types of raw materials as described above with respect to the high molecular weight polyurethane resins. However, because of the lower degree of polymerization, it is possible to incorporate a higher level of branching into these resins. As a result, the high equivalent weight polyols and the polyisocyanates may have average functionalities that are somewhat higher than mentioned before. High equivalent weight polyol average functionalities in this case may be from about 1.8 to about 4, and preferably are about 2 to about 3.5. Polyisocyanate average functionalities are suitably within the same ranges.

Again due to the low degree of polymerization, it is possible to incorporate a higher level of crosslinkers and chain extenders into the curable polyurethane resins. Crosslinkers and chain extenders are conveniently used in amounts up to about 1 equivalent per equivalent of high equivalent weight isocyanate-reactive material.

The number average molecular weights of the curable polyurethane resin is consistent with being a viscous fluid or low-melting solid, such as from about 3000 to about 25,000, preferably from about 8000 to about 25,000. Molecular weight control is generally achieved by two mechanisms. Use of an excess of polyisocyanate compounds over isocyanate compounds (or vise versa) limits molecular weight by exhausting the supply of the limiting reagent(s). In addition to limiting molecular weight, this creates a resin having isocyanate- or isocyanate-reactive end groups that can engage in further curing during the expansion step. Isocyanate indices of less than about 0.7, especially from 0.1 to about 0.5, or above 1.5, especially from 2 to 10, will typically result in the desired low molecular weight polyurethane resin. Another method is to provide into the reaction mixture mono-functional species (monoisocyanates, monoalcohols or monoamines, for example) that act as chain terminators and thus limit the molecular weight of the resin.

Because these curable polyurethane resins are liquids or low-softening solids, it is often convenient to prepare them in a first step and subsequently compound them with the blowing agent, surfactant, and other components. This procedure reduces the need to control temperature conditions during the resin forming reaction, as there is no concern about prematurely activating the blowing agent or premature cure. Compounding is easier as well because it is not necessary to use high temperatures to soften the resin for compounding it with other components. Nonetheless, it is within the scope of the invention to prepare the curable polyurethane resin in the presence of the blowing agent, surfactant and other components, if desired.

Preparation of a curable resin is conveniently done in the same general manner as described before with respect to the heat-softenable types. Since the reaction product is a viscous liquid or low-softening material, it is conveniently mixed and dispensed into a reaction vessel in which the polyurethane-forming reaction is completed. The resulting resin is then transferred to suitable packaging for subsequent use. The reaction is preferably conducted so that the resulting resin contains less than 20% by weight, especially less than 12% by weight, more preferably less than 5% by weight of volatile organic materials, in particular isocyanate compounds of less than about 300 molecular weight.

Curable polyurethane resins contain functional groups that enable the resin to cure during the heat expansion step. Examples of such groups include free or blocked isocyanate groups; free or blocked hydroxyl, thiol or amine groups; carbodiimide groups; free or blocked carboxylic acid groups; ethylenically unsaturated groups; and other types of polymerizable groups.

Free isocyanate groups are most readily introduced into the polyurethane resin by using a stoichiometric excess of the polyisocyanate component, to form an isocyanate-terminated prepolymer or oligomer. Another method is to use an isocyanate compound that has at least two isocyanate groups of unequal reactivity to prepare the resin. Reaction conditions are then selected so only the more reactive of the isocyanate groups reacts to form the resin, and the less reactive groups remains free to react further during the expansion step. Yet another method is to use a carbodiimide-modified polyisocyanate to make the resin. At elevated temperatures, the carbodiimide groups can decompose to generate free isocyanate groups.

Free isocyanate groups can engage in a variety of heat-activated crosslinking/curing reactions. Among these are trimerization; allophonate and/or biruet formation, polyurethane formation and polyurea formation.

To cure an isocyanate-containing polyurethane resin through a trimerization reaction, the polyurethane composition is advantageously formulated with a trimerization catalyst. Trimerization catalysts are well-known, and include alkali metal salts and strongly basic materials. Trimerization reactions generally require an elevated temperature, so polyurethane compositions containing an isocyanate-containing polyurethane resin and trimerization catalysts are usually storage stable at temperatures below 50° C. To increase storage stability, or increase the temperature at which the trimerization reaction occurs, the isocyanate groups can be blocked, such as with methyl ethyl ketoxime, and/or a heat-activated or encapsulated catalyst may be used. An encapsulated catalyst is preferably encapsulated in a material that melts or decomposes at the expansion temperature. Suitable encapsulated catalysts materials and methods are described in U.S. Pat. Nos. 5,601,761 and 6,224,793, both incorporated herein by reference.

To affect a cure via biuret and/or allophonate formation, the polyurethane composition may be formulated with a urethane catalyst. In many cases, this reaction proceeds at elevated temperatures even without a catalyst, and typically does not occur at temperatures below 50° C. If a catalyst is used, it may be a heat-activated type or encapsulated type, with suitable encapsulating materials being as described before. In addition, the isocyanate groups may be blocked to prevent premature reactions or to modify the temperature at which biuret and/or allophonate reactions take place.

Curing an isocyanate-containing polyurethane resin via urethane formation requires that the polyurethane composition be formulated with a source of hydroxyl groups. Several measures may be taken to prevent premature reaction, such as using blocking the isocyanate groups on the resin, encapsulating the source of hydroxyl groups, or formulating the composition with a heat-activated or encapsulated catalyst. Compounds having a two or more hydroxyl groups are useful curing agents in this embodiment of the invention. Among such compounds, those described above for use in preparing the polyurethane resin are suitable. The most suitable of those compounds are the crosslinker and/or chain extender materials described above. Another suitable source of hydroxyl groups is water, which can be encapsulated in a low-melting solid encapsulating material to prevent premature. When water is used, it will produce carbon dioxide gas, which assists in expanding the foam, in addition to curing the resin via urea formation. Other suitable hydroxyl-containing curing agents include hydroxyl-containing polymers such as polyvinyl alcohol and poly(hydroxyalkyl)acrylate and methacrylate polymers. Among these acrylate and methacrylate polymers are polymers and copolymers of hydroxylethyl acrylate, hydroxyethyl methacrylate, hydroxybutyl acrylate, hydroxylbutyl methacrylate, and other hydroxyalkyl esters of acrylic or methacrylic acid.

Similarly, curing agents containing primary or secondary amine groups can be present in the polyurethane composition to provide a cure via urea formation. Amino-group containing chain extenders and crosslinkers described above are suitable for this purpose, as are aminoalcohols described before. In addition, polymers containing primary and secondary amino groups are useful curing agents, such as polyethyleneimine, polyacrylamide and polymers and copolymers of aminoethyl acrylate, aminoethyl methacrylate, aminobutyl acrylate, aminobutyl methacrylate and other aminoalkyl esters of acrylic or methacrylic acid. As amino groups are very highly reactive with isocyanate groups, measures are necessary to prevent premature curing. These include blocking the isocyanate groups on the resin as before, blocking the amino groups, or encapsulating the amine-containing curing agent with an encapsulant as described before. Amino groups can be blocked with an organic or carboxylic acid or anhydride, such as HCl, an alkali metal salt of such an acid, such as NaCl. Blocked amine curing agents such as those made by the reaction of approximately equimolar amounts of an anhydride and a polyamine, as described in U.S. Pat. No. 4,766,183, are also useful. A commercially available blocked amine chain extender is PACAM blocked aromatic diamine, available from Bayer.

If not encapsulated, hydroxyl- or amine-containing curing agents should be compatible with the polyurethane resin and should also have low volatility so they do not produce strong odors or vapors during storage and use. Compatibility is sufficient that the curing agents do not phase-separate from the polyurethane resin during storage.

A polyurethane resin containing free hydroxyl groups is readily prepared by using an excess of hydroxyl-containing reactants to make the resin. Free hydroxyl groups can engage in heat-activated curing reaction such as polyurethane formation and ester formation.

An isocyanate-containing compound must be incorporated into the polyurethane composition to effect a cure via urethane group formation. Polyisocyanates as described before are suitable, although as before precautions are usually needed to prevent premature reaction. Blocked polyisocyanates are preferred. Commercially available blocked polyisocyanates that are suitable include Desmodur BL XP 7162, Desmodur BL 4265 and Desmodur BL 3175A, all from Bayer. Alternatively, the polyisocyanate may be encapsulated in the manner discussed before with respect to catalysts and water.

Curing by ester formation is achieved by incorporating into the polyurethane composition a poly(carboxylic acid), poly(carboxylic acid halide) or anhydride thereof. Examples of such materials include phthalic anhydride, terphthalic anhydride, pyromellitic anhydride and polymers and copolymers of acrylic or methacrylic acid. The reaction of hydroxyl with carboxylic acid, acid halide or anhydride groups generally proceed slowly if at all at temperatures below about 40° C. The polyurethane composition may be formulated with a catalysts for the esterification reaction, including various tin compounds such as SnCl₂, SnBr₂, SnCl₄, SnBr₄, SnO, organotin compounds such as tin (II) bis(2-ethyl hexanoate), butyltin tris(2-ethyl hexanoate), hydrated monobutyltin oxide, dibutyltin dilaurate, tetraphenyltin and the like; PbO, zinc alkoxides, zinc stearate, organoaluminum compounds such as aluminum alkoxides, organoantimony compounds such as antimony triacetate and antimony (2-ethyl hexanoate), organobismuth compounds such as bismuth (2-ethyl hexanoate), calcium stearate, magnesium stearate, certain yttrium and rare earth compounds such as are described in U.S. Pat. No. 5,208,667 to McLain et al, and the like. To prevent premature curing or to adjust the curing temperature to the correct range, the catalyst and/or the curing agent may be encapsulated or otherwise heat-activated.

Amino groups are conveniently incorporated into the polyurethane resin by (1) using an excess of a polyamine to form the resin or (2) forming a resin having free isocyanate groups, and then hydrolyzing the isocyanate groups to form primary amino groups. Free amino groups in the resin can engage in a variety of heat-activated curing reactions, for example, with isocyanates, epoxies to form cured epoxy resins, carboxylic acids, acid halides or anhydrides to form amides, and with compounds or polymers having ethylenic unsaturation via a Michaels addition. Polyisocyanates can be compounded into the polyurethane composition as described before, but are preferably blocked or encapsulated to prevent premature curing.

Suitable epoxy resins for use in curing an amine-functional polyurethane resin include cycloaliphatic epoxides, epoxidized novolac resins, epoxidized bisphenol A or bisphenol F resins, butanediol polyglycidyl ether, and neopentyl glycol polyglycidyl ether, but generally preferred on the basis of cost and availability are liquid or solid glycidyl ethers of a bisphenol such as bisphenol A or bisphenol F. Halogenated, particularly brominated, resins can be used to impart flame retardant properties if desired. The epoxy resin may be solid, and if so, preferably has a melting temperature approximating the expansion temperature. Solid epoxy resins having a melting temperature within the range of 50-205° C., especially 100-160° C. are particularly suitable. Liquid epoxy resins are preferably encapsulated, or else are used in conjunction with a heat-activated or encapsulated catalyst.

Carboxylic acids, acid halides and acid anhydrides suitable for curing an amine-functional polyurethane resin are as described above, and are used in the same manner.

Compounds having a plurality of ethylenically unsaturated groups can also be compounded into the polyurethane composition to cure with amino groups on the polyurethane resin. These engage in Michaels addition reactions with the amino groups. These materials may be encapsulated to prevent premature reaction.

Examples of such ethylenically unsaturated materials include adducts of a polyisocyanate and a hydroxy-functional acrylate or methacrylate. These materials containing terminal acrylate (CH₂═CH—C(O)—) or methacrylate (CH₂═C(CH₃)—C(O)—) groups. Suitable hydroxy-functional acrylates and methacrylates include 2-hydroxyethyl acrylate, 2-hydroxyethyl methacrylate (HEMA), 2-hydroxylpropyl acrylate, 2-hydroxypropyl methacrylate, 4-hydroxy-n-butyl acrylate, 2-hydroxy-n-butyl acrylate, 2-hydroxy-n-butyl methacrylate, 4-hydroxy-n-butyl methacrylate, poly(oxyethylene)- and/or poly(oxypropylene)-esters of acrylic or methacrylic acid, wherein the number of oxyethylene and/or oxypropylene groups is preferably from about 2 to about 10, and the like. Of the foregoing, the methacrylates are preferred, especially when the polyol component contains primary amine compounds. HEMA is especially preferred.

Another example of a material having ethylenic unsaturation is a “hydroxyvinyl ester” formed by reacting acrylic or methacrylic acid with an epoxy resin, as described in U.S. Pat. No. 5,091,436 to Frisch et al., incorporated herein by reference. The resulting hydroxyvinyl ester contains one or more free hydroxyl groups as well as terminal acrylate or methacrylate groups. These esters generally have a molecular weight of about 300 to about 600.

Yet another type of material having ethylenic unsaturation is an adduct of a polyhydroxy compound and fatty acid having one or more sites of carbon-carbon unsaturation in the fatty acid chain. Among such fatty acids are palmitoleic, oleic, linoleic, linolenic, α-eleostearic acid, catalpic acid, punicic acid, calendic acid, jacaric acid, α-parinaric acid and bosseopentaenoic acid. These adducts are conveniently formed by reaction of the polyhydroxy compound with the fatty acid, fatty acid alkyl ester or fatty acid halide. They can also be formed in a transesterification reaction between the polyhydroxy compound and a triglyceride of the fatty acid (such as a naturally-occurring animal fat or vegetable oil).

Ethylenic unsaturation can be incorporated into the polyurethane resin through the use of unsaturated polyols such as castor oil or a hydroxyl-functional ethylenically unsaturated compound such as the acrylate and methacrylate monomers described before. These can engage in curing reactions by vinyl polymerization with other like groups; by vinyl polymerization with other ethylenically unsaturated materials in the polyurethane composition, or by reaction with polyamine compounds (such as those describe before, particular the amine chain extender materials) in a Michaels addition reaction. In the first two cases, premature reaction can be prevented by use of a heat-activated free-radical initiator, control over temperatures, and/or the use of free-radical scavengers or other vinyl polymerization inhibitors that can be compounded into the polyurethane composition. An example of such an ethylenically unsaturated material which will react with polymerizable ethylenic unsaturation in the polyurethane resin is a polyfunctional (meth)acrylate compound having a plurality of acrylate or methacrylate groups and an equivalent weight of up to 3000, preferably from about 100 to about 2000, and especially between about 100 and 300 daltons per acrylate or methacrylate group. Among these materials are esters of acrylic acid and/or methacrylic acid with one or more polyalcohols that have on average at least two alcohol groups per molecule. Suitable such compounds are commercially available under the trade name Sartomer™, and include trimethylolpropane trimethacrylate (Sartomer 350), trimethylolpropane triacrylate, di(trimethylolpropane) tetraacrylate (Sartomer 355), di(trimethylol propane) tetramethacrylate, 2-proprionic acid, 2-(hydroxylmethyl)-2-((1-oxo-2-propenyl)oxy)methyl) and similar compounds. Another commercially available compound is CT 2800, available from Cybertech Chemicals, Ltd., New Windsor, N.Y. Other types of ethylenically unsaturated materials can be used as well. However, highly reactive monomers, volatile monomers and monomers that are not compatible with the polyurethane composition are less preferred.

A range of other, optional components can be incorporated into the polyurethane composition. These include plasticizers, modifiers, flame retardants, fillers, reinforcing agents, colorants, preservatives, antioxidants, UV stabilizers, free radical inhibitors, cell openers and the like.

Examples of plasticizers include chlorinated biphenyls, and aromatic oils such as VYCUL™ U-V (sold by Crowley Chemicals) and Jayflex™ L9P (sold by Exxon Chemicals). The amount of plasticizer, when used, may range over a wide range depending on the foam properties desired. Generally, the plasticizer, when present, ranges from about 0.5 percent to at most about 30%, preferably from about 2 to about 20 percent by weight of the foam formulation.

Other modifiers such as polysulfide polymer, triphenyl phosphite and various polyamides can be incorporated into the polyurethane composition if desired.

Examples of suitable flame retardants include phosphorous compounds, halogen-containing compounds and melamine.

Examples of fillers and pigments include calcium carbonate, titanium dioxide, talc, mica, iron oxide, chromium oxide, azo/diazo dyes, phthalocyanines, dioxazines and carbon black. Fillers can be used to reduce cost and modify physical properties. When a low molecular weight, curable polyurethane resin is used, the filler can also be used to increase viscosity and rheological properties, for example to form a “thumbable” putty-like material. Up to 1 part by weight of filler or more can be used per part by weight polyurethane resin.

Examples of UV stabilizers include hydroxybenzotriazoles, zinc dibutyl thiocarbamate, 2,6-ditertiarybutyl catechol, hydroxybenzophenones, hindered amines and phosphites.

Free radical inhibitors such as p-benzoquinone are useful to help prevent the acrylate and/or methacrylate compounds from polymerizing during storage and even during the foam curing.

Examples of cell openers include silicon-based antifoamers, waxes, finely divided solids, liquid perfluorocarbons, paraffin oils and long chain fatty acids.

Except as otherwise noted above, the foregoing additives are generally used in small amounts, such as from about 0.01 percent to about 1 percent by weight of the foam formulation.

As mentioned before, these additives are preferably present during the formation of the polyurethane resin, when the resin is heat-softenable above 100° C. They are most conveniently compounded into liquid or low-softening polyurethane resins in a separate step from the resin-forming step, although it is possible to incorporate them into the resin-forming step as well.

The following examples are provided to illustrate the invention, but are not intended to limit the scope thereof. All parts and percentages are by weight unless otherwise indicated.

### EXAMPLE 1

An expandable polyurethane polymer is prepared by processing the components identified in Table 1 through a reaction injection molding machine. Components are at ˜25° C. prior to mixing.

TABLE 1

| | Nominal | Equivalent | | |
|---|---|---|---|---|
| Component | Functionality | Weight | Equivalents/Weight | |
| “A-side” | | | | |
| Polyether Polyol A¹ | 3 | 2000 | 0.5 | equivalent |
| Polyether Polyol B² | 3 | 1000 | 1.0 | equivalent |
| 1,4-butanediol | 2 | 45 | 0.45 | equivalent |
| Blowing Agent A³ | — | — | 3% | by weight |
| Silicone Surfactant A⁴ | — | — | 2% | by weight |
| Catalyst A⁵ | — | — | 0.07% | by weight |
| “B-side” | | | | |
| “Liquid MDI”⁶ | 2 | 143 | 2 | equivalents |

¹An ethylene oxide-capped poly(propylene oxide), available as Voranol ™ 28 polyol from The Dow Chemical Company.
²A poly(propylene oxide)polyol available as Voranol ™ 232-056, from The Dow Chemical Company.
³A azobiscarbonamide blowing agent, available as Celogen ™AZ120 blowing agent from Crompton Industries.
⁴A silicone surfactant available as Tegostab ™B8870 from Th. Goldschmidt.
⁵An organotin catalyst available as T-12 catalyst from Air Products and Chemicals.
⁶A modified methylene diphenyldiisocyanate available as Isonate ™143L from Dow Chemical.

The resulting molded polymer is a tack-free, melt-softenable polymer. A portion of it is applied to a metal plate, and the plate and polymer are heated to 150-175° C. for about 30 minutes. After 12-15 minutes at this temperature, the polymer softens and begins to expand. Expansion continues until the volume reaches about 300% of the original (unexpanded) volume. This resin can form allophonate groups during the expansion step to provide additional crosslinking and stabilize the foam structure. Upon cooling to room temperature, a stable, flexible polyurethane foam adhered to the substrate is obtained.

### EXAMPLE 2

An expandable polyurethane polymer is prepared by processing the components identified in Table 2 through a reaction injection molding machine. The B-side/A-side equivalent ratio is 0.38; the weight ratio is 1:10. Component temperatures are ˜25° C. prior to mixing.

TABLE 2

| | Nominal | Equivalent | | |
|---|---|---|---|---|
| Component | Functionality | Weight | Weight-% | |
| “A-side” | | | | |
| Copolymer Polyol A¹ | 3 | 2640 | 67.95 | wt-% |
| Castor Oil | 2.7 | 1000 | 14 | wt-% |
| Blowing Agent B² | — | — | 10 | wt-% |
| Surface-treated urea³ | — | — | 0.985 | wt-% |
| Microspheres⁴ | — | — | 5 | wt-% |
| Catalyst A⁵ | — | — | 0.1 | wt-% |
| Silicone Surfactant B⁶ | — | — | 2 | wt-% |
| “B-side” | | | | |
| Prepolymer⁷ | 2.46 | 143 | | |

¹An experimental ethylene oxide-capped poly(propylene oxide) containing 43% dispersed styrene-acrylontrile particles.
²An azobiscarbonamide blowing agent, available from Crompton Industries as Celogen ™765A blowing agent.
³BlK-OT, from Uniroyal.
⁴Expandcel U053, from Expandcel Inc.
⁵See note 5, table 1.
⁶A silicone surfactant available from Air Products and Chemicals as DC-198 surfactant.
⁷An isocyanate-terminated MDI prepolymer.

The resulting product is a tack-free, melt-softenable, isocyanate-terminated polymer. A portion of it is applied to a metal plate, and the plate and polymer are heated to 150-175° C. for about 30 minutes. Under these conditions, the polymer expands to about 2600% of its original volume. Curing is provided by reaction of unsaturated groups derived from the castor oil and by reactions of the free isocyanate groups in the resin. Upon cooling to room temperature, a stable, flexible polyurethane foam with a density of 3.5 pounds/cubic foot is formed and adhere to the substrate.

### EXAMPLE 3

An expandable polyurethane polymer is prepared by processing the components identified in Table 3 through a reaction injection molding machine. The B-side/A-side equivalent ratio is 0.31 the weight ratio is 1:12.5. Components are at ˜25° C. prior to mixing.

TABLE 3

| | Nominal | Equivalent | Party by |
|---|---|---|---|
| Component | Functionality | Weight | Weight |
| “A-side” | | | |
| Copolymer polyol A¹ | 3 | 2640 | 66.95 |
| Castor Oil | 2.7 | 340 | 10 |
| Blowing Agent B² | — | — | 10 |
| Surface-treated urea³ | — | — | 0.95 |
| Microspheres⁴ | — | — | 10 |
| Catalyst B⁵ | — | — | 0.1 |
| Surfactant⁶ | — | — | 2 |
| “B-side” | | | |
| Prepolymer⁷ | 3.01 | 429 | 100 |

¹See note 1, table 2.
²See note 2, table 2.
³See note 3, Table 2.
⁴See note 4, table 2.
⁵See note 5, table 1.
⁶See note 6, table 2.
⁷An isocyanate-terminated prepolymer of a polymeric MDI.

The resulting molded polymer is a tack-free, melt-softenable elastomer having free isocyanate groups. A portion of it is applied to a metal plate, and the plate and polymer are heated to 149° C. for about 30 minutes. Under these conditions, the polymer expands to about 2600% of its original volume. Curing is provided by reaction of unsaturated groups derived from the castor oil and by reactions of the free isocyanate groups in the resin. Upon cooling to room temperature, a stable, flexible polyurethane foam with a density of 3.5 pounds/cubic foot is formed and adhered to the substrate.

### EXAMPLE 4

An expandable polyurethane polymer is prepared by processing the components identified in Table 4 through a reaction injection molding machine. The B-side/A-side equivalent ratio is 0.31 and the weight ratio is 1:12.5. Components are at about ˜25° C. before mixing.

TABLE 4

| | Nominal | Equivalent | |
|---|---|---|---|
| Component | Functionality | Weight | Weight-% |
| “A-side” | | | |
| Copolymer polyol A¹ | 3 | 2640 | 66.45 |
| Castor Oil | 2.7 | 340 | 10 |
| Blowing Agent B² | — | — | 10 |
| Surface-treated urea³ | — | — | 0.95 |
| Microspheres⁴ | — | — | 10 |
| Catalyst B⁵ | — | — | 0.1 |
| Silicone surfactant B⁶ | — | — | 2 |
| Methyl Ethyl | — | — | 0.5 |
| Ketoxime⁷ | | | |
| “B-side” | | | |
| Prepolymer⁸ | 3.01 | 429 | 100 |

¹See note 1, table 3.
²⁻⁴See notes 2-4, table 2.
⁵See note 5, table 1.
⁶See note 6, table 2.
⁷An isocyanate blocking agent from Tech Solutions.
⁸See note 7, table 3.

The resulting polymer is a semi-solid material. A portion of it is applied to a metal plate, and the plate and polymer are heated to 149° C. for about 30 minutes. Under these conditions, the polymer expands to about 3000% of its original volume. Curing is provided by reaction of unsaturated groups derived from the castor oil and by reactions of the free isocyanate groups in the resin. Upon cooling to room temperature, a stable, flexible polyurethane foam with a density of 2-3 pounds/cubic foot is formed and adhered to the substrate.

1. A process for applying an adherent flexible polyurethane foam to a substrate, comprising
(a) applying to the substrate an expandable, one-component, bulk polyurethane composition, containing a polyurethane resin having dispersed therein (1) a surfactant and (2) a blowing agent that is heat-activated at an elevated temperature, then
(b) heating said bulk polyurethane composition to a temperature sufficient to activate said blowing agent to generate a gas, whereby said bulk polyurethane resin expands to form a flexible polyurethane foam adherent to the substrate, and
(c) then cooling the resulting polyurethane foam to a temperature below 40 C.

2. The process of claim 1, wherein the polyurethane resin is heat-softenable at a temperature above 100° C.

3. The process of claim 1, wherein the polyurethane resin undergoes further curing reaction during the heating and expansion step.

4. The process of claim 2, wherein the polyurethane resin is heat-softenable at a temperature above 100° C.

5. The process of claim 2, wherein the polyurethane resin is a viscous liquid or a solid that is heat-softenable at a temperature below 100° C.

6. The process of claim 3, wherein the polyurethane resin contains free isocyanate groups.

7. The process of claim 6 wherein the polyurethane composition contains a trimerization catalyst, a blocked amine curing agent, a hydroxyl curing agent, or encapsulated water.

8. The process of claim 3, wherein the polyurethane resin contains free hydroxyl groups.

9. The process of claim 8, wherein the polyurethane composition contains a blocked polyisocyanate compound or a material having carboxylic acid, carboxylic acid halide or carboxylic acid anhydride groups.

10. The process of claim 3, wherein the polyurethane resin contains free amine groups.

11. The process of claim 10, wherein the polyurethane composition contains a blocked isocyanate compound, an epoxy resin, or a material having a plurality of ethylenically unsaturated sites.

12. The process of claim 3, wherein the polyurethane resin contains polymerizable ethylenic unsaturation.

13. The process of claim 12, wherein the polyurethane composition contains a heat-activated free radical initiator or a polyamino compound.

14. The process of claim 1, wherein the substrate is an automotive part or assembly or automotive parts.

15. The process of claim 14, wherein the automotive part or assembly of automotive parts is mounted onto a vehicle or vehicle frame when the foam formulation is applied.

16. The process of claim 15, wherein the automotive part or assembly is a pillar, rocker, sill, sail, cowl, plenum, seam, frame rail, cross bar beam, engine cradle or hydro-formed part.
